(19) United States
(12) Patent Application Publication
(10) Pub. No.: US 2005/0151769 A1
(43) Pub. Date: Jul. 14, 2005

(54) Method and system for compensating for systematic variability in fluid ejection systems to improve fluid ejection quality

(75) Inventors: Andrew S. Yeh, Portland, OR (US); Glenn K. Smith, Webster, NY (US)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/754,694

(22) Filed: Jan. 12, 2004

(51) Int. Cl. B41J 29/38

(52) U.S. Cl. 347/9

(57) ABSTRACT

A printing apparatus and method for replacing or augmenting a misplaced black or color pixel during printing with a properly placed black, gray, or color pixel; and for altering the pass in which a black or color pixel is printed by a printhead to improve print quality.

### BACKGROUND OF THE INVENTION

1. Field of Invention

This invention is related to improving fluid ejection quality for fluid ejections systems such as, for example, ink-jet printers, by compensating for systematic variability in the fluid ejection system.

2. Description of Related Art

In fluid ejection systems such as, for example, thermal ink-jet printers, a fluid ejector head typically includes one or more fluid ejectors. Each fluid ejector typically includes a channel that communicates with a fluid supply chamber, or a manifold, at one end, and an opening at the opposite end of each fluid ejector. The opening at the opposite end of each fluid ejector is typically referred to as a nozzle. Fluid is expelled from each nozzle by a process, such as, for example, the process known as “drop-on-demand” printing or the process known as continuous stream printing.

In a color fluid ejection system such as, for example, a color ink-jet printing apparatus, the head typically includes a linear array of ejectors. The fluid ejector head is typically moved relative to the surface of a fluid receiving sheet, either by moving the fluid receiving sheet relative to a stationary fluid ejector head, or vice versa, or both. In fluid ejection systems such as, for example, an ink-jet printing apparatus, a fluid ejector head typically reciprocates across a fluid receiving sheet numerous times. In the fluid ejection systems such as, for example, ink-jet printers, this occurs in the course of printing an image. Each pass of the fluid ejector head across the fluid receiving sheet is typically referred to as a swath. As the fluid ejector head and the fluid receiving sheet are moved relative to each other, image-type digital data is typically used to selectively activate the fluid ejectors in the head to generate a desired fluid pattern, such as, in the example of an ink printer, an image.

### SUMMARY OF THE DISCLOSURE

A ubiquitous problem in fluid ejection systems such as, for example, inkjet printers is the proper placement of fluid on a fluid receiving medium. Spot misplacement of fluid on the fluid receiving medium often has several causes. These causes include variations in the speed or direction of the ejected fluid drops, deflection of the fluid drops by a variable air flow, and errors in the positioning of a fluid receiving medium or a fluid ejecting nozzle.

Due to market pressure to produce fluid ejectors with higher throughput and higher quality, the design of a fluid ejector head is generally governed by a delicate balance between fluid jetting frequency and fluid jetting reliability. It is believed that the most reliable fluid jetting is achieved by waiting for a fluidic equilibrium before jetting the fluid. However, higher fluid jetting frequencies are achieved by jetting the fluid before the fluid reaches equilibrium, and by accepting some amount of variation in the drop shape or speed of the jetted fluid. In particular, jetting the fluid before a fluid nozzle has been refilled generally results in a smaller, faster fluid drop than a fluid drop ejected at fluid equilibrium. Jetting a fluid drop when the fluid drop's meniscus is bulging out of the fluid nozzle opening generally results in a larger, slower fluid drop.

One particular fluid jetting defect is referred to as the “line split”problem. This problem is observed in many fluid ejector heads. For example, in an inkjet printer, a print sample of, for example, all jets of a single color firing three pixels, all jets of a single color firing four pixels, or greater, may have a white gap near the nominal position of the second pixel because the second drops are consistently misplaced. Sometimes printed lines of a single color having a nominal thickness of two pixels may appear to be slightly narrower than they ought to appear. The immediate cause of this problem is believed to be often due to a fluid difference in drop speed between a second fluid drop and a first, third, and fourth fluid drop, under certain firing conditions. It is also believed that an occasional cause of the line split problem are misdirected jetted fluid drops from the fluid heads.

Therefore, a need exists for a fluid ejection system and method wherein a systematic variability in a fluid ejector is compensated for, thus achieving improved fluid ejection quality.

Various exemplary embodiments of the systems and methods of this invention compensate for systemic variability in a fluid ejection system by analyzing data that is sent to a fluid ejector head. In certain exemplary embodiments, this data is analyzed at a printer driver level. In certain other exemplary embodiments, this data is analyzed at a firmware level. In certain other exemplary embodiments, this data is analysed at both the printer driver level and the firmware level.

In various exemplary embodiments of a fluid ejection system that is an inject printer this invention determines which single color pixels will be affected by the previously mentioned line split problem. In various exemplary embodiments of the systems and methods of this invention, pixels are identified by one or more of a combination of factors, including, but not limited to, a fluid ejection mode, a fluid receiving type, a swath direction of a fluid ejector head, a swath height of a fluid ejector head, a fluid jet alignment of, in some exemplary embodiments, an image, fluid ejector head jetting characteristics, a fluid pixel color, a distance of fluid pixels to a leading edge, and a distance of a leading edge to a previous trailing edge or an edge of a fluid receiving medium.

In various exemplary embodiments, this invention provides systems and methods for improving print quality by modifying the printing pass in which a pixel is printed.

In various exemplary embodiments, this invention separably provides systems and methods for improving print quality by replacing systematically misplaced single color pixels with pixels of different colors.

In various exemplary embodiments, this invention separably provides systems and methods for reducing line split errors.

In various exemplary embodiments, this invention separably provides systems and methods for improving fluid ejection accuracy by compensating for systematic variability in fluid ejection systems.

### BRIEF DESCRIPTION OF THE DRAWINGS

Various exemplary embodiments of the systems and methods of this invention will be described in detail, with reference to the following figures, wherein:

FIG. 1 is a schematic diagram of one exemplary embodiment of a method and system for compensating for systematic variability in fluid ejection systems to improve fluid ejection quality according to this invention.

FIG. 2 is a partially fragmented isometric view of an exemplary embodiment of a color ink-jet printer having replaceable ink-jet supply tanks according to this invention;

FIG. 3 is a partially exploded isometric view of an exemplary embodiment of an ink-jet cartridge with an integral printhead, integral ink connectors and a replaceable ink tank, according to this invention; and

FIG. 4 is a flowchart outlining an exemplary embodiment of a method for providing an error corrected image according to this invention.

### DETAILED DESCRIPTION OF EXEMPLARY EMBODIMENTS

The following detailed description of various exemplary embodiments of the fluid ejection systems according to this invention may refer to one specific type of fluid ejection system, an ink-jet printer, for sake of clarity and familiarity. However, it should be appreciated that the principles of this invention, as outlined and/or discussed below, can be equally applied to any known or later developed fluid ejection systems, beyond the ink-jet printer specifically discussed herein.

In various exemplary embodiments of the systems and methods of this invention, certain identified fluid pixels are masked. In these various exemplary embodiments, these masks replace affected fluid pixels with a combination of cyan, magenta and yellow ink to produce a processed black ink. In various exemplary embodiments of the systems and methods of this invention, the amount of black ink replacement is empirically determined for each print mode and for each print media type. In various exemplary embodiments, the amount of black ink replacement is minimal. In various exemplary embodiments, the amount of black ink replacement is excessive.

Various exemplary embodiments of the systems and methods of this invention advantageously increase the amount of ink placed at identified pixel locations to compensate for color differences between single color pixels that are pure and those that are processed. According to various exemplary embodiments of the systems and methods of this invention, pure single color pixels such as black pixels are replaced with processed alternative color pixels such as, for example, “blue” pixels, magenta on cyan pixels, or various other variations of yellow, magenta or cyan pixels.

In various exemplary embodiments of the systems and methods of this invention, involving bidirectional, multi-pass printing, the pass in which a pixel is printed is modified and used in conjunction with, or without, the various embodiments incorporating the masking concept previously described. Various exemplary embodiments of the systems and methods of this invention, move the pixel firing position to an earlier or later pass, in the same or opposite direction of a pass where a pixel would normally be printed. Various exemplary embodiments of the systems and methods of this invention determine the circumstances where this occurs. Various exemplary embodiments of the systems and methods of this invention change the printed pixel's position to a leading edge. Thus, various exemplary embodiments of the systems and methods of this invention avoid the line split problem altogether, and advantageously improve print image quality.

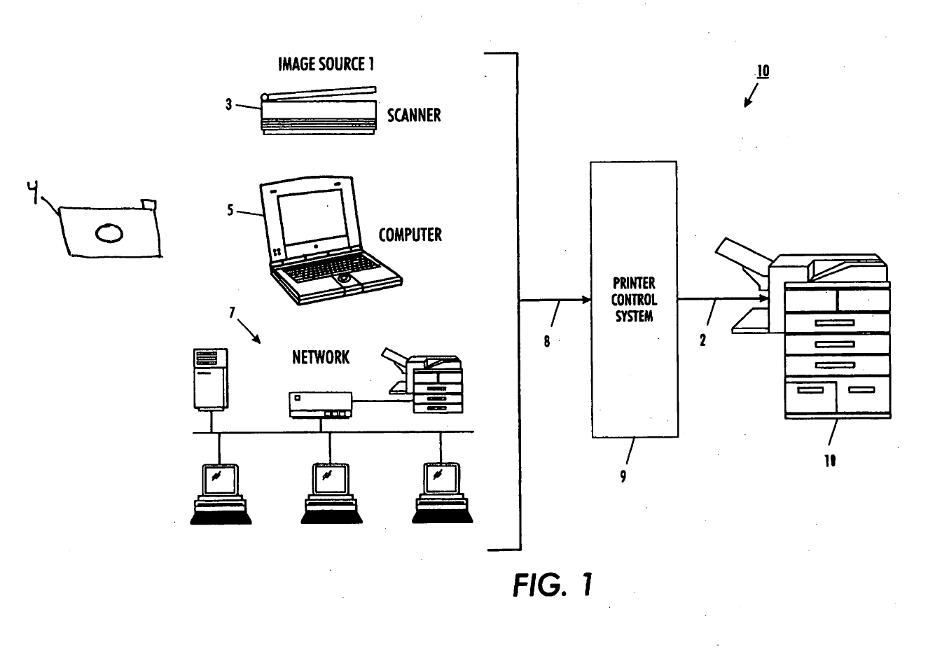

FIG. 1 is a schematic diagram of one exemplary embodiment of a method and system for compensating for systematic variability in fluid ejection systems to improve fluid ejection quality according to this invention.

There is shown an exemplary printing system 10, including an image source 1. In various exemplary embodiments, the image source 1 includes a scanner 3, a camera and/or video camera 4, a computer 5, and a network 7. In various exemplary embodiments, the scanner 3, the camera and/or video camera 4, the computer 5, and the network 7 are image sources that provide an image data 8. In various exemplary embodiments, the image data 8 is a combination of ASCII data, a bitmapped image, geometric data, graphics primitives, page description language, or the like.

In various exemplary embodiments, image data 8 is supplied to a printer control system 9. In various exemplary embodiments, the printer control system 9 processes the image data 8 to produce print data 2. In various exemplary embodiments, the print data 2 drives a printer 11. In various exemplary embodiments, the printer control system 9 comprises what is sometimes referred to as a print driver.

It should be apparent that, in various exemplary embodiments, the printer control system 9 is implemented in hardware and/or software and resides within the image source 1, within the printer 11, within a separate component, or within a combination of the image source 1, the printer 11, and the like. In various exemplary embodiments, print data 2 comprises image data 8 and/or printer control signals, such as, for example, a paper handling signal, a carriage control signal, or an ink deposition signal. In various exemplary embodiments, the printer 11 generates an output image on a suitable print medium in response to the print data 2. For illustrative purposes, the printer 11 will be discussed as comprising an ink-jet printer. In various exemplary embodiments, the printer 11 is a device other than an inkjet printer.

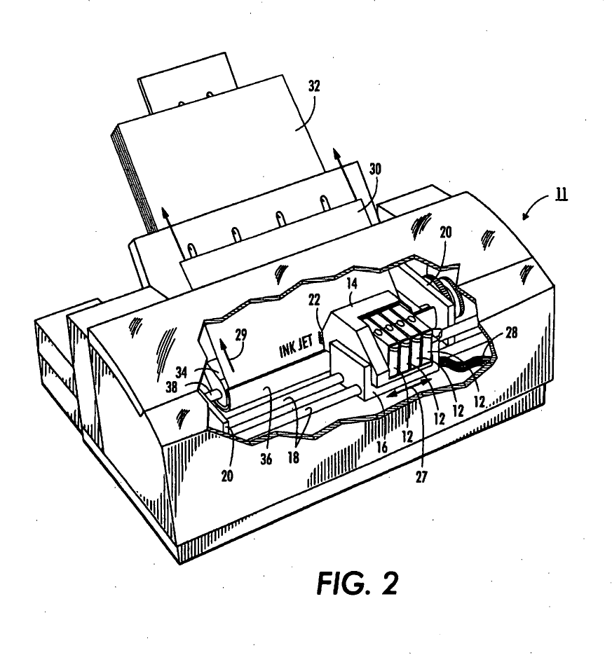

FIG. 2 is a partially fragmented isometric view of an exemplary embodiment of a color ink-jet printer having replaceable ink-jet supply tanks according to this invention.

Various exemplary embodiments of this invention include a multicolor thermal inkjet printer 11. In various exemplary embodiments, the exemplary printer 11 includes four replaceable ink supply tanks 12 mounted in a removable ink-jet cartridge 14. In various exemplary embodiments, the ink supply tanks 12 each contain a different color of ink. In various exemplary embodiments, the tanks 12 have yellow, magenta, cyan, and black ink, respectively. In various exemplary embodiments, the removable cartridge 14 is installed on a translatable carriage 16 which is supported by carriage guide rails 18. In various exemplary embodiments, the carriage guide rails 18 are fixedly mounted in a frame 20 of the printer 11. In various exemplary embodiments of this invention, the removable cartridge consumes or depletes the ink from at least ten ink supply tanks 12 of the same color of ink. In various exemplary embodiments, the ink supply tanks 12 are refilled from a separate reservoir. In various exemplary embodiments, a plurality of printheads are mounted on the carriage 16, with one ink tank 12 connected to an individual printhead. In various exemplary embodiments of this invention, the carriage 16 is translated back and forth along the guide rails 18 by a means under the control of the printer control system 9. In various exemplary embodiments, any well-known means is used to translate the carriage 16 along the guide rails 18.

In various exemplary embodiments, the carriage 16 reciprocates back and forth along the guide rails 18 in the direction of the arrow 27 when printing. In various exemplary embodiments, as the printhead 22 reciprocates back and forth across a recording medium 30, droplets of ink are expelled from selected ones of the printhead nozzles towards the recording medium 30. In various exemplary embodiments, the recording medium is a single cut sheet of paper that is fed from an input stack 32 of sheets. In various exemplary embodiments, the nozzles are arranged in a linear array perpendicular to the direction of the arrow 27. In various exemplary embodiments, the recording medium 30 is held in a stationary position during each pass of the carriage 16. In various exemplary embodiments, at the end of each pass, the recording medium 30 is stepped in the direction of arrow 29. U.S. Pat. No. 4,571,599 includes a more detailed explanation of an exemplary embodiment of such a printhead and of exemplary embodiments of associated printing methods, and is incorporated herein by reference in its entirety.

In various exemplary embodiments, a single sheet of the recording medium 30 is fed from an input stack 32 through the printer 11 along a path defined by a curved platen 34 and a guide member 36. The sheet 30 is driven along that path by a transport roller 38. Various exemplary embodiments are illustrated in U.S. Pat. No. 5,534,902, incorporated herein by reference in its entirety. In various exemplary embodiments, as the recording medium 30 exits a slot between the platen 34 and the guide member 36, the recording medium 30 reverse bows such that the recording medium 30 is supported by a flat portion of the platen 34 for printing by the printhead 22.

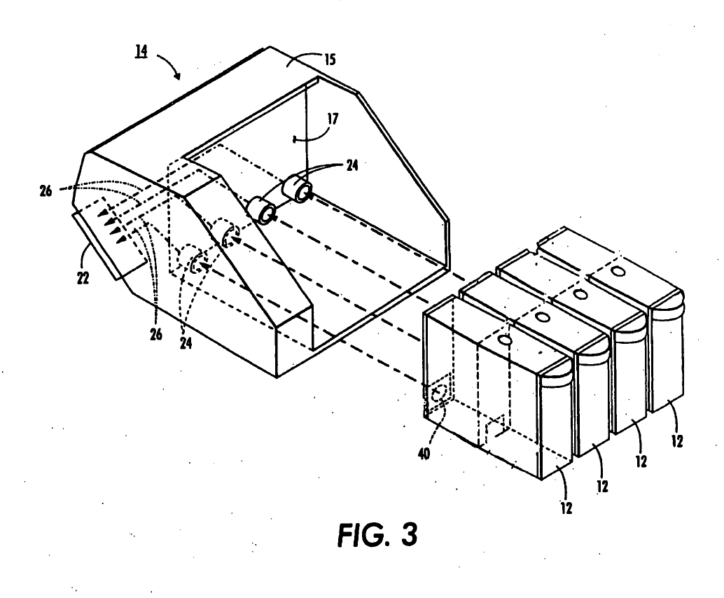

FIG. 3 is a partially exploded isometric view of an exemplary embodiment of an ink-jet cartridge with an integral printhead, integral ink connectors and a replaceable ink tank, according to this invention.

In various exemplary embodiments according to this invention, the ink-jet cartridge 14 includes a housing 15 having an integral multicolor ink-jet printhead 22 and ink pipe connectors 24 that protrude from a wall 17 of the cartridge 14 for insertion into ink tanks 12 when the ink tanks 12 are installed in the cartridge housing 15. In various exemplary embodiments of this invention, ink flow paths, represented by dashed lines 26, in the cartridge housing 15 interconnect each of the ink connectors 24 with separate inlets of the printhead 22.

In various exemplary embodiments according to this invention, the ink-jet cartridge 14, including the replaceable ink supply tanks 12 that contain ink for supplying ink to the printhead 22, further includes an interfacing printed circuit board (not shown) that is connected to the printer 11 and controlled by a ribbon cable 28. In various exemplary embodiments according to this invention, as shown in FIG. 2, electric signals are selectively applied through the ribbon cable 28 to the printhead 22 to selectively eject ink droplets from printhead nozzles (not shown). In various exemplary embodiments, the printhead 22 is a multicolor printhead and contains a plurality of ink channels (not shown) that carry ink from each to the ink tanks 12 to respective groups of ink ejecting nozzles of the printhead 22.

In various exemplary embodiments, ink from each of the ink supply tanks 12 is drawn by a capillary action through an outlet port 40 in the ink supply tanks 12, the ink pipe connectors 24, and inflow paths 26 in the cartridge housing 15 to the printhead 22. In various exemplary embodiments, the ink pipe connectors 24 and the flow paths 26 of the cartridge housing 15 supply ink to the printhead ink channels, and replenish the ink after ejecting each ink droplet from the nozzle that is associated with the printhead ink channel. In various exemplary embodiments, the ink at the nozzles is maintained at a slightly negative pressure, so that the ink is prevented from dripping onto the recording medium 30. The negative pressure also assists in ensuring that ink droplets are placed on the recording medium 30 only when a droplet is ejected by an electrical signal applied to a heating element in the ink channel for the selected nozzle. In various exemplary embodiments, the negative pressure is in the range of −0.5 to −5.0 inches of water. One known method of supplying ink at a negative pressure is to place within the ink supply tanks 12 an open cell foam or needled felt in which ink is absorbed and suspended by a capillary action. Ink tanks which contain an ink holding material are disclosed, for example, in U.S. Pat. Nos. 5,185,614; 4,771,295, and 5,486,855, incorporated herein by reference in their entirety.

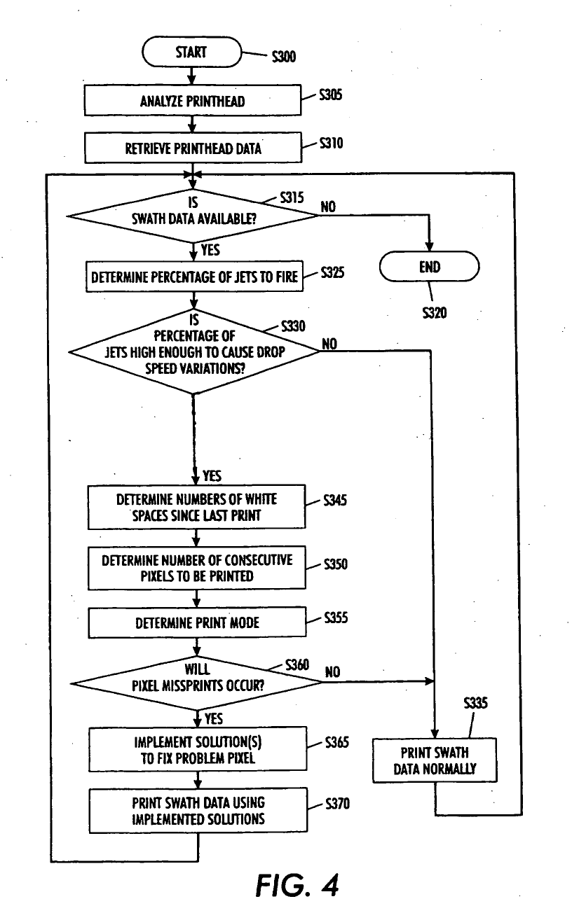

FIG. 4 is a flowchart outlining an exemplary embodiment of a method for providing an error corrected image according to this invention. Starting at step S300, processing proceeds to step S305, where a printhead is analyzed. In various exemplary embodiments, the analysis of the printhead enables a determination of how to achieve consistent drop speeds by taking into account the geometry of the printhead, the characteristic operating conditions of the printhead, and the physical properties of the ink. In various exemplary embodiments, the analysis of the printhead enables a determination of consistent variations in drop speed by taking into account the geometry of the printhead, the characteristic operating conditions of the printhead, and the physical properties of the ink. Each printhead has a characteristic refill frequency, which depends on the size of the printhead ink channels, the viscosity and surface tension of the ink, and the pressure put on the ink supply tank. When an ink ejector fires faster than the refill frequency of the printhead, the first drop is fired at regular speed because the printhead is full of ink at equilibrium, and the second drop is fired out of the printhead faster than the first drop, is smaller than the first drop, and may land on an unintended position on the paper or other type of intended receiving medium, because the ink ejector was not fill of ink when the second drop was fired.

If multiple ink ejectors are fired at, or close to, the same time, multiple pressure pulses may be desirable to eject the ink. In various exemplary embodiments, these pressure pulses are also conveyed through the inflow paths to the neighboring ink ejectors, which cause the menisci in the nozzles of the neighboring (unfired) ink ejectors to bulge as pressure is applied, or recede when pressure is taken away. As a result, in various exemplary embodiments, when the neighboring ink ejectors do fire, the meniscus is not at rest in the printhead, but rather bulging or recessive. In various exemplary embodiments, when the meniscus is recessive due to the negative pressure applied to the nozzle, a small, fast drop will be ejected from the nozzle, but if the meniscus is bulging, then a large, slow drop will instead be ejected from the nozzle.

If, for example, for a given printhead, 75% of all ink ejectors on the printhead are fired, in various exemplary embodiments, an analysis of the printhead may reveal that for the first two consecutively printed pixels, the second pixel is not printed properly, because the printhead fired the ink for the second pixel at a faster than normal velocity. In various exemplary embodiments, this is determined, for example, by printing a solid swath of several thousand pixels, and observing a gap at, for example, the beginning of the swath corresponding to the nominal position of the second pixel. Thus, in various exemplary embodiments, the drop fired corresponding to the second pixel is too small and light on the paper or other type of receiving medium, while the first, third, fourth, fifth, and sixth pixels, etc., are all printed the correct size and color intensity.

In various exemplary embodiments of this invention, several variables may be determined from an analysis of a given printhead, including but not limited to: single ink ejector firing rate, the number of ejectors being fired in a single stroke, where each stroke generally translates into one printed pixel on the page if the ejector fires, the number of drops fired in a row, and the amount of time since the last ink ejector fired. Further, in various exemplary embodiments, from these variables, it is determined, how many ink ejectors in a single stroke need to be fired before a printing problem occurs (the printing problem jet firing percentage), how many pixels in a row need to be printed before a printing problem occurs, and which (x, y) pixel positions on the receiving medium will have the problem.

Processing next proceeds to step S310, at which point the printhead data determined by the analyze printhead step S305 is retrieved and stored for later processing.

Processing next proceeds to step S315, where it is determined if swath data is available to be printed. According to various exemplary embodiments, such swath data may include, but is not limited to, for example, a block of data equal to the height of the printhead and the width of the page. If no swath data is available, then processing proceeds and ends at step S320, because no data is being sent to the printer to be printed. If, however, swath data is available, then processing proceeds to step S325.

At step S325, a determination is made as to the percentage of jets which need to be fired for a given set of swath data. For example, according to various exemplary embodiments, for a given block of swath data, there are different ways in which the swath data may be printed by the printer, which are generally determined by the print mode and number of passes used to print the swath data. With one pass printing, for example, all of the swath data is printed either left to right or right to left. Thus, the swath data is generally analyzed either from left to right or right to left. In various exemplary embodiments, if a two-pass printing mode is utilized by the printer, generally a printer controller, or printer controlling software, such as a printer driver in an image source, determines how much ink will be printed on the page for the current block of swath data. For example, in various exemplary embodiments, if the printer is to deposit one drop of ink per pixel on the page over two passes, in one direction the printer will fire 50% of the jets each stroke to print 50% of the swath data, and in the other direction the printer will print the remaining 50% of the swath data using 50% jet capacity. In various exemplary embodiments, when three drops are deposited on the receiving medium for every pixel of swath data and four passes are used, then each pass prints 75% of the swath data utilizing only 75% of the jets each stroke. In various exemplary embodiments, this percentage is stored as a variable, and processing next proceeds to step S330.

In step S330, based on the percentage of ink ejectors to be fired determined in step S325, it is determined if the percentage of jets or ink ejectors to be fired is high enough to cause variations in ink drop firing speed by comparing the jet firing percentage determined in step S325 with the percentage of ink ejectors needed before a printing problem occurs, as determined at step S305. In various exemplary embodiments, if the percentage of jets or ink ejectors to be fired is less than the printing problem jet firing percentage, then no drop speed variations occurs for the given swath data, and processing proceeds to step S335, at which point the current swath data is printed normally as no printing problems will occur. Otherwise, in various exemplary embodiments, a potential printing problem might occur because the percentage of jets to be fired is greater than or equal to the printing problem jet firing percentage, and processing next proceeds to step S345.

At step S345, it is determined how many white spaces have occurred between successive firing of an ink ejector. According to various exemplary embodiments, not printing for at least three (or any number determined by an analysis of the print-head) pixels allows the ink ejector to refill with ink. In various exemplary embodiments, if, for example, it is known through analysis of the printhead that it will take 100 μs for a printing problem to recover, then in step S345 it is determined how many pixels that time translates into based on the drop ejection frequency and the carriage speed of the printer. Thus, in various exemplary embodiments, this time-value is translated into a pixel distance (the number of pixels). In various exemplary embodiments, step S345 is repeated for every ink ejector. Processing next proceeds to step S350.

At step S350, the number of consecutive pixels to be printed by each ink ejector is determined. According to various exemplary embodiments, two or more pixels are printed in a row before a printing problem occurs. However, in various exemplary embodiments, the actual number of consecutive pixels printed before a printing problem occurs is determined at step S305, and obtained at the retrieve printhead data step S310. In various exemplary embodiments, step S350 is repeated for every ink ejector. Processing next proceeds to step S355.

At step S355, the print mode is determined. In various exemplary embodiments, the type of printing being performed is beneficial to determine what type, if any, of error correcting routine or circuit to utilize. Some photographs or grayscale prints, for example, do not use solid black ink. Thus, in various exemplary embodiments, there is no need to fix a black pixel, as the printhead isn't utilized in this instance. Instead, in various exemplary embodiments, the black pixel is substituted using combinations of CMY ink. However, in various exemplary embodiments, for printing typical black text, a printed black pixel may need to be corrected. Further, in various exemplary embodiments, print modes determined in step S355 include one pass or multi-pass print modes. Processing next proceeds to step S360.

At step S360, it is determined if pixel misprints will occur. In various exemplary embodiments, this is based on at least the number of jets or ink ejectors being fired, the number of white spaces or the time since a pixel was last printed, the number of consecutive pixels being fired onto the receiving medium, and the print mode. If it is determined that no pixel misprints will occur based on at least the above recited data, then processing proceeds to step S335, where the swath data is printed without error-correction routines. Otherwise, processing proceeds to step S365.

At step S365, it is known which pixels in the swath data will have a printing problem. Therefore, in various exemplary embodiments, one or both of the following solutions is/are utilized: (1) substitute the problem pixel with a different color of ink, and/or (2) change, physically, which pass the problem pixel is printed in.

In various exemplary embodiments, solution (1) is implemented as follows: Based on the surrounding pixels, a determination is made to print black with a combination of cyan, magenta, or yellow (CMY) inks using methods of image processing to minimize hue shifts. For example, a determination is made to print either a cyan, magenta, and yellow (CMY) pixel, which produces a composite black, pseudo black, dark gray, or gray color when the identified problem pixel is surrounded by a significant amount of black color, to print a cyan and magenta (CM) pixel, which produces a slightly different shade of black when there is little surrounding black color around the identified problem pixel, or to print a blue pixel to replace the identified problem pixel in an area where black and color ink, mixed together, are surrounding the identified problem pixel.

In various exemplary embodiments, for solution (2), the print scheduling for the identified problem pixel is performed by hardware or software. In various exemplary embodiments, as the controlling hardware or software schedules which pass pixels in the swath data are printed, a pixel is moved to a different pass within by the scheduling software or circuit. According to various exemplary embodiments, this is achieved by using a print mask. In various exemplary embodiments, the print mask stores a 1 or 0 for every pixel location within the swath data. In various exemplary embodiments, this indicates whether or not to print a pixel on the receiving medium for a corresponding location in the swath data. In various exemplary embodiments, the print mask also stores a number corresponding to the pass during which a given pixel will be printed. Thus, in various exemplary embodiments, if a pixel location has a ‘1’ stored, and the print mask for the current pass is equal to ‘1’, then a pixel is printed on the receiving medium corresponding to its position within the swath data on the first pass. In various exemplary embodiments, there is generally one mask per pass, i.e., for one pass printing modes there is one mask, for two pass printing modes there are two masks, for three pass printing modes there are 3 masks, etc. In various exemplary embodiments, changing the pass in which a pixel is printed is achieved by changing the pixel's print mask.

Processing then proceeds to step S370.

In step S370, swath data is printed using the implemented solutions. After step S370 and step S335, processing returns to step S315, and continues until no more swath data is available.

This invention has been described in conjunction with the exemplary embodiments outlined above. Various alternatives, modifications, variations, and/or improvements, are within the spirit and scope of the invention whether known or presently unforeseen. Accordingly, the exemplary embodiments of the invention, as set forth above, are intended to be illustrative, not limiting. Various changes may be made without departing from the spirit and scope of the invention. Therefore, the invention is intended to embrace all known or later developed alternatives, modifications, variations and/or improvements.

1. A method for controlling a fluid ejecting apparatus having at least one printhead to print swaths of at least one fluid on a receiving medium, each of the at least one printheads having a plurality of nozzles that eject the same or different fluids, a first nozzle ejecting a first one of the same or different fluids, a second nozzle ejecting a second one of the same or different fluids, and additional nozzles ejecting additional same or different fluids, the method comprising:
receiving ejection data from a data source;
determining correction data corresponding to potential misprinted pixels based on the received ejection data; and
controlling the printhead to eject the first fluid from the first nozzle based on the received ejection data, and controlling the printhead to eject the second same or different fluids from the second nozzle and the additional same or different fluids from the additional nozzles based on the determined correction data.

2. The method according to claim 1, further comprising:
receiving printhead characteristics;
determining correction data corresponding to potential misprinted pixels based on the received printhead characteristics.

3. The method according to claim 1, wherein the first fluid is black in color, and the second fluid forms a light gray color pixel or the second fluid and the additional fluids combine to form the light gray color pixel.

4. The method according to claim 1, wherein the first fluid is black in color, and the second fluid forms a composite black color pixel or the second fluid and the additional same or different fluids combine to form the composite black color pixel.

5. The method according to claim 1, wherein the first fluid is black in color, and the second fluid forms a blue color pixel or the second fluid and the additional same or different fluids combine to form the blue color pixel.

6. The method according to claim 1, wherein the first fluid is of any color, and the second fluid is the same color as the first fluid or the second fluid and the additional same or different fluids are the same color as the first fluid.

7. A method of controlling a fluid ejecting apparatus ejecting fluid onto a receiving medium having a printhead to print swaths on a receiving medium, comprising:
receiving swath pixel data from a data source;
determining potential misprinted pixels based on the received swath pixel data;
segregating the received swath pixel data into at least two data segments, including a first data segment and a second data segment, based on the determined potential misprinted pixels; and
ejecting fluid corresponding to the first data segment during a first pass, and ejecting fluid corresponding to the second data segment during a second pass, different than the first.

8. The method according to claim 7, further comprising:
receiving printhead characteristics; and
determining potential misprinted pixels based on the received printhead characteristics.

9. The method of claim 7, further comprising:
changing a data segment of a potential misprinted pixel to avoid a misprint.

10. A fluid ejection system that ejects fluids onto a receiving medium, comprising:
at least one fluid ejecting head that prints swaths of at least one fluid on a receiving medium, the at least one fluid ejecting head having a plurality of nozzles that eject the same or different fluids, a first nozzle ejecting a first one of the same or different fluids, a second nozzle ejecting a second one of the same or different fluids, and additional nozzles ejecting additional same or different fluids;
a receiver configured to receive ejection data from a data source;
a determining unit configured to determine correction data corresponding to potential misprinted pixels based on at least the received ejection data; and
a controller configured to control the fluid ejection head to eject the first fluid from the first nozzle based on the received ejection data, and configured to eject the second fluid from the second nozzle based on the determined correction data.

11. The fluid ejection system of claim 10, wherein the receiver is also configured to receive fluid ejection head characteristics, and wherein the determining unit is also configured to determine potential misprinted pixels based on the received fluid ejection head characteristics.

12. The fluid ejection system of claim 10, wherein the first fluid is black in color, and the second fluid forms a composite black color pixel or the second fluid and the additional same or different fluids combine to form the composite black color pixel.

13. The fluid ejection system of claim 10, wherein the first fluid is black in color, and the second fluid forms a blue color pixel or the second fluid and the additional same or different fluids combine to form the blue color pixel.

14. The fluid ejection system of claim 10, wherein the first fluid is black in color, and the second fluid is light gray color pixel, or the second fluid and additional same or different fluids combine to form the light gray color pixel.

15. The fluid ejection system of claim 10, wherein the first fluid is any color, and the second fluid is the same color as the first fluid or the second fluid and the additional same or different fluids are the same color as the first fluid.

16. A fluid ejection system that ejects fluids onto a receiving medium, comprising:
a receiver configured to receive swath pixel data from a data source;
a determining unit configured to determine correction data corresponding to potential misprinted pixels based on at least the received swath pixel data; and
a controller configured to eject fluid in one or more passes over the receiving medium.

17. The fluid ejection system of claim 16, wherein the receiver is also configured to receive printhead characteristics, and wherein the determining unit is configured to determine potential misprinted pixels based on the received printhead characteristics.

18. The fluid ejection system of claim 16, wherein the segregating unit is configured to segregate the potential misprinted pixels into multiple passes over the receiving medium in order to avoid a misprint.
